(19) United States
(12) Patent Application Publication
(10) Pub. No.: US 2018/0277348 A1
(43) Pub. Date: Sep. 27, 2018

(54) Electron Ionization (EI) Utilizing Different EI Energies

(71) Applicant: Agilent Technologies, Inc., Santa Clara, CA (US)

(72) Inventors: Harry F. Prest, Mountain View, CA (US); Mingda Wang, Fremont, CA (US); Jeffrey T. Kernan, Santa Cruz, CA (US)

(21) Appl. No.: 15/996,033

(22) Filed: Jun. 1, 2018

Related U.S. Application Data
(63) Continuation of application No. 13/925,470, filed on Jun. 24, 2013, now abandoned.

(51) Int. Cl. H01J 49/08; H01J 49/14; H01J 49/00

(52) U.S. Cl. CPC H01J 49/08; H01J 49/147; H01J 49/0031

(57) ABSTRACT

Mass spectrometry is performed utilizing an electron ionization (EI) source. The EI source ionizes a sample at different electron energies, including below and above 70 eV. The EI source may be utilized for soft ionization as well as hard ionization. The value of the electron energy may be selected so as to favor the formation of molecular ions or other ions of high analytical value. The ion source may be an axial ion source.

### RELATED APPLICATIONS

The present application is a continuation application under 37 C.F.R. § 1.53(b) of commonly owned U.S. patent application Ser. No. 13/925,470, filed on Jun. 24, 2013, the content of which is incorporated by reference herein in its entirety.

### TECHNICAL FIELD

The present invention relates to electron ionization (EI) as utilized in mass spectrometry, and more particularly to acquisition of mass spectra by performing EI at different electron energies.

### BACKGROUND

A mass spectrometry (MS) system in general includes an ion source for ionizing components of a sample of interest, a mass analyzer for separating the ions based on their differing mass-to-charge ratios (or m/z ratios, or more simply “masses”), an ion detector for counting the separated ions, and electronics for processing output signals from the ion detector as needed to produce a user-interpretable mass spectrum. Typically, the mass spectrum is a series of peaks indicative of the relative abundances of detected ions as a function of their m/z ratios. The mass spectrum may be utilized to determine the molecular structures of components of the sample, thereby enabling the sample to be qualitatively and quantitatively characterized.

One example of an ion source is an electron ionization (EI) source. In a typical EI source, sample material is introduced into a chamber in the form of a molecular vapor. A heated filament is employed to emit energetic electrons, which are collimated and accelerated as a beam into the chamber under the influence of a potential difference impressed between the filament and an anode. The sample material is introduced into the chamber along a path that intersects the path of the electron beam. Ionization of the sample material occurs as a result of the electron beam bombarding the sample material in the region where the sample and electron paths intersect. The primary reaction of the ionization process may be described by the following relation: M+e⁻→M*⁺+2e⁻, where M designates an analyte molecule, e⁻ designates an electron, and M*⁺ designates the resulting molecular ion. That is, electrons approach a molecule closely enough to cause the molecule to lose an electron by electrostatic repulsion and, consequently, a singly-charged positive ion is formed. A potential difference is employed to attract the ions formed in the chamber toward an exit aperture, after which the resulting ion beam is accelerated into a downstream device such the mass analyzer or first to an intervening component such as an ion guide, mass filter, etc.

The sample may be introduced into the EI source by various techniques. In one example, a gas chromatograph (GC) is interfaced with the MS such that the sample output from the GC column—containing chromatographically separated sample components—serves as the sample input into the ion source. The latter system is often termed a GC/MS system. Gas chromatography (GC) entails the analytical separation of a vaporized or gas-phase sample that is injected into a chromatographic column. The sample is injected into the carrier gas stream and the resulting sample-carrier gas mixture flows through the column. During column flow the sample encounters a stationary phase (a coating or packing), which causes different components of the sample to separate according to different affinities with the stationary phase. The separated components elute from the column exit at different times. This enables the MS to ionize the separated components separately and analyze the different sets of ions produced from the separated components separately, which may significantly enhance the accuracy of the analysis and ability to identify chemical compounds.

It has been standard practice in EI operations to use a constant electron energy that is typically set to 70 eV. This is because a wide range of compounds have optimal fragmentation at 70 eV, “optimal” meaning a high degree of fragmentation useful for identification and a large cross-section available for ionization in general, which results in an abundant overall ion signal. The default 70-eV energy level has been employed to build extensive spectral libraries. However, 70 eV is not the optimal energy for all compounds of interest. In particular this rather high level of energy, as compared to the ionization potential of many types of molecules, tends to produce few of the higher mass ions that are helpful for chemical identification, accurate mass spectrometry experiments, and tandem MS/MS or related experiments involving consecutive fragmentation. In particular, the hard ionization effected at 70 eV tends to produce few molecular (or polyatomic) ions. Molecular ions and other higher mass ions are very useful but are discriminated against at the high energy operation of conventional EI. Lower energy (less than 70 eV) electrons can produce less fragmentation (softer ionization) when competing fragmentation pathways require more energetic ionization. Hence, in comparison to standard ionization at 70 eV, ionization at lower energy can favor formation of molecular ions or at least more high mass ions, thereby preserving more information regarding chemical structure and facilitating identification of unknown compounds.

Quantum mechanics has shown that the cross-section for electron impact scales linearly to electron energy as the electron energy approaches the ionization potential, or appearance potential (the minimum electron energy required to produce an ion from a gas phase atom or molecule). This means that as the energy of the ionizing electron is lowered, the yield of ions from the ionization process also is lowered, and eventually vanishes as the electron energy falls below the ionization potential. This has been shown to be a nearly linear function as the energy approaches the ionization potential. Thus, a lower energy EI methodology would appear to be impractical. When ionization at lower energies is called for, a researcher typically discards EI and instead turns to a conventional soft ionization technique such as chemical ionization (CI). Several MS instruments have ion sources capable of being switched between EI and CI, adding cost and complexity.

In view of the foregoing, there is a need for EI sources capable of ionizing sample materials over a range of energies, both below and above 70 eV, in an effective manner, thereby rendering EI a more universal approach to ionization operations. There is also a need for EI sources capable of preferentially forming an abundance of molecular ions and/or other high mass ions favorable to experiments involving specific compounds, classes of compounds, and sample matrices. There is also a need for methods for ionization and spectral data acquisition that exploit the ability to perform EI over a range of energies.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a method for acquiring mass spectral data includes: producing an electron beam in an electron ionization (EI) source at a first electron energy; introducing a sample comprising an analyte of interest into the EI source; irradiating the sample with the electron beam at the first electron energy to produce first analyte ions from the analyte of interest; transmitting the first analyte ions into a mass analyzer to generate a first mass spectrum correlated to the first electron energy; adjusting the electron energy to a second electron energy different from the first electron energy; irradiating the sample with the electron beam at the second electron energy to produce second analyte ions from the analyte of interest; and transmitting the second analyte ions into the mass analyzer to generate a second mass spectrum correlated to the second electron energy.

According to another embodiment, a method for acquiring mass spectral data includes: selecting at least a first electron energy and a second electron energy at which an electron ionization (EI) source is to operate, wherein the second electron energy is different from the first electron energy; producing an electron beam in the EI source; introducing a sample into the EI source, wherein the sample is known to include or suspected of including at least a first analyte of interest and a second analyte of interest; irradiating the sample with the electron beam at the first electron energy to produce a first set of ions; transmitting the first set of ions out from the EI source; adjusting the electron energy to the second electron energy; irradiating the sample with the electron beam at the second electron energy to produce a second set of ions; and transmitting the second set of ions out from the EI source, wherein the first electron energy is selected to preferentially produce a first target analyte ion known to be characteristic of the first analyte of interest, and the second electron energy is selected to preferentially produce a second target analyte ion known to be characteristic of the second analyte of interest.

According to another embodiment, a mass spectrometer is configured for performing any of the methods disclosed herein.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a flow diagram illustrating an example of a method for acquiring mass spectral data according to an embodiment.

FIG. 2 is a flow diagram illustrating an example of a method for acquiring mass spectral data according to another embodiment.

FIG. 3 is a schematic view of an example of a mass spectrometry (MS) system in which methods as disclosed herein may be implemented and ion sources as disclosed herein may be provided.

FIG. 4 is a perspective view of an example of an ion source according to some embodiments.

FIG. 5 is a perspective cross-sectional view of the ion source illustrated in FIG. 4.

FIG. 6 is a schematic view of a portion of the ion source illustrated in FIGS. 4 and 5 according to another embodiment.

FIG. 7 illustrates mass spectra for n-tetracontane acquired by EI with 70 eV (upper spectrum) and 11 eV (lower spectrum) of electron energies, respectively.

FIG. 8 illustrates mass spectra for 2,2′,3,4′,6,6′-hexachloro-1,1′-biphenyl acquired by EI with 70 eV (upper spectrum) and 13 eV (lower spectrum) of electron energies, respectively.

### DETAILED DESCRIPTION

The present disclosure is directed to mass spectrometry (MS) in which electron ionization (EI) is employed as the ionization technique. The present disclosure describes methods and EI sources in which EI is implemented at different electron energies, not only at 70 eV but also at energies lower and/or higher than 70 eV. This approach takes into account that various analytes of interest do not all have exactly the same slope for the ionization yield versus EI energy as they approach the ionization threshold, and that molecular ions and other high mass ions are frequently absent from spectra produced using standard 70-eV EI. For example, it may be determined that ionizing a given analyte at 10 eV produces the most favorable abundance of a molecular ion, while ionizing a different analyte at 20 eV produces the most favorable abundance of a molecular ion for that analyte. In such a case, according to the present disclosure the EI source may be programmed to ionize the first analyte at 10 eV and the second analyte at 20 eV. Ionizing at two different electron energies may be done in two separate experiments (sample runs), or during the course of a single experiment. In the latter case, for example, the sample may be introduced into the EI source as an elution from a chromatography column (typically a gas chromatography, or GC, column), such that the first analyte and second analyte have been separated by retention time and thus sequentially enter the EI source. The electron energy levels, and the timing and duration of application of those levels, may be programmed into the EI source so that the EI source irradiates the first analyte at 10 eV, adjusts the electron beam, and then irradiates the second analyte at 20 eV.

In some embodiments, operating the EI source with adjusted or varied electron energies may be utilized to survey an analyte over a range of electron energies to find an electron energy that is optimal for forming a particular molecular ion or fragment ion from that analyte, thereby improving identification and other attributes. For example, during the chromatographic elution time of an analyte (e.g., six seconds), the electron energy may be switched or adjusted (e.g., every one second) to different values (including, for example, the standard 70-eV energy) to ascertain molecular features as a function of the electron energy utilized for ionization. Adjustment may entail, for example, switching from an initial value to two or more successively higher or lower values (e.g., 10 eV, 20 eV, 30 eV, 40 eV, . . . ), or cycling between a high value and a low value (e.g., 50 eV, 20 eV, 50 eV, 20 eV, . . . ) or cycling through three or more different values (e.g., 10 eV, 20 eV, 50 eV, 10 eV, 20 eV, 50 eV, . . . ).

These methods may be utilized to compile extensive libraries (or databases, or look-up tables, etc.) for a wide range of different analytes. The libraries may contain data which, for each analyte, associates mass spectra with the EI energies utilized to generate the respective spectra, and/or associates target analyte ions with the EI energies utilized to generate the respective target analyte ions. In the present context, a “target” analyte ion is in general any ion known or considered to be characteristic of a given analyte, i.e., an ion of high analytical value in ascertaining the identity of a given analyte. Depending on the analyte, a target analyte ion may often be a molecular ion or high mass ion, but may also be a lower mass fragment ion. In the present context, a high mass ion is an ion having a mass near the molecular mass of the analyte from which the high mass ion was formed. An EI energy that yields a high abundance of the target analyte ion may be referred to herein as a “target” electron energy for that target analyte ion.

Methods and EI sources disclosed herein thus enable the EI source to implement hard ionization or soft ionization, and to switch between hard ionization and soft ionization (including during the same experiment), as desired or needed for optimizing the ionization and mass analysis processes for a given analyte or set of analytes. According to the present disclosure, the EI source may be employed in many cases in which conventionally EI is discarded in favor of a conventional soft ionization process such as chemical ionization (CI). Accordingly, the EI source and methods disclosed herein make the EI source a more universal ionization device in comparison to other devices such as CI sources and conventional EI sources.

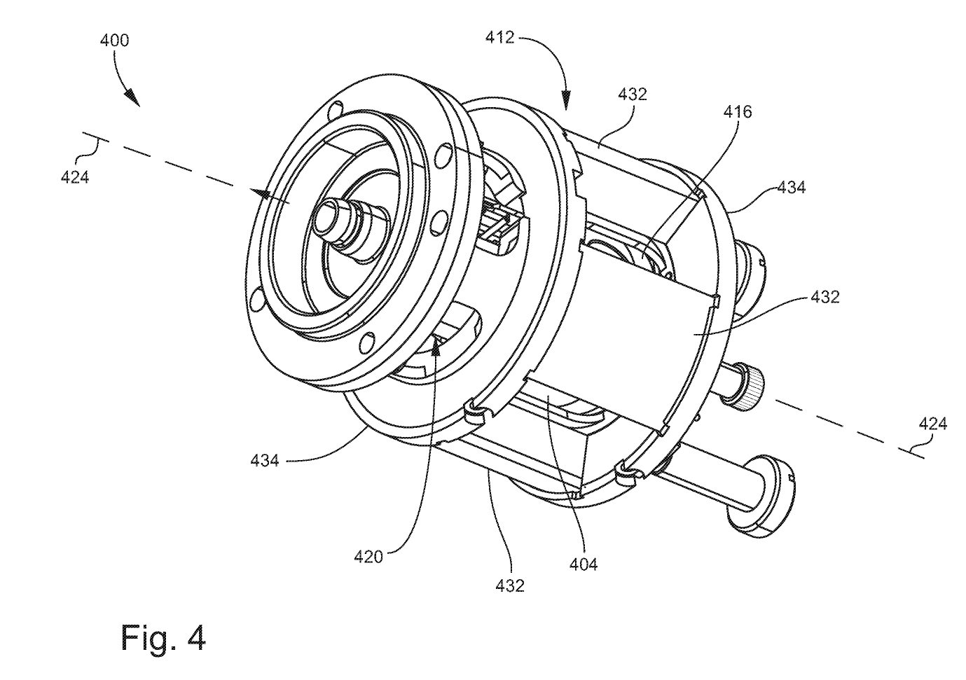

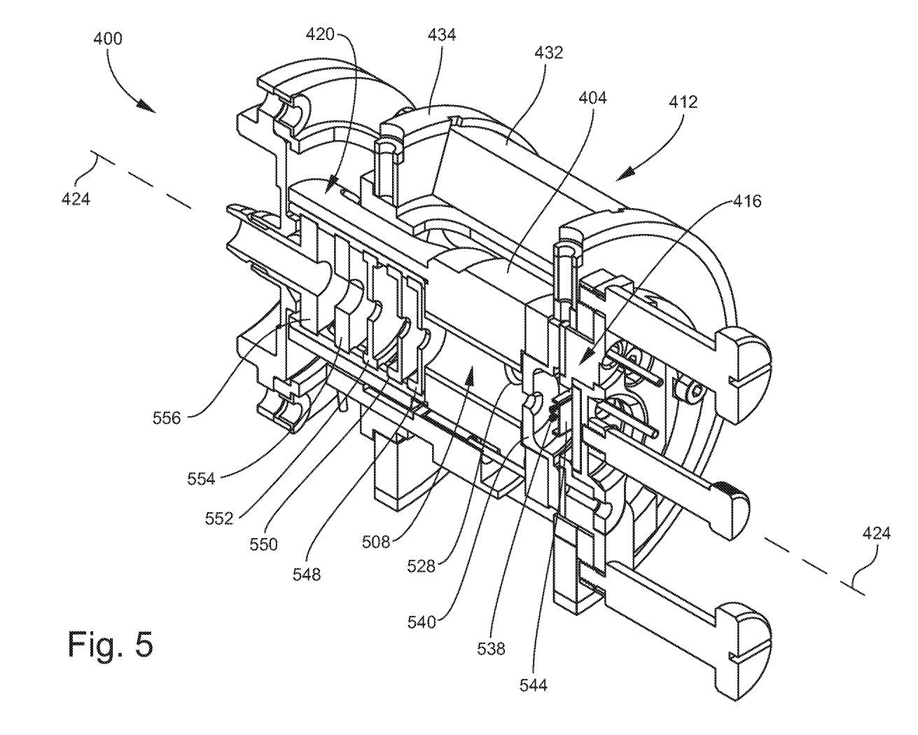

In typical embodiments, the EI source includes a cathode or filament that emits electrons by thermionic emission. The emitted electrons are then focused into an electron beam by a potential difference between the cathode and an anode, and optionally also by application of a magnetic field. The energy of the electron beam may be adjusted by adjusting the voltage applied to the filament, thereby adjusting the current through the filament. In some embodiments, the electron beam may be adjusted over a range from 9 eV to 150 eV. Electron energies less than 70 eV, for example in a range from 9 eV to 25 eV, may be considered as being within the regime of soft ionization. The present disclosure provides EI sources capable of effectively implementing EI over these ranges of electron energies. Even at very low energies, the EI sources disclosed herein are capable of producing an electron beam with an intensity and ionization yield sufficient for many experiments. A non-limiting example of an EI source is described below and illustrated in FIGS. 4 and 5.

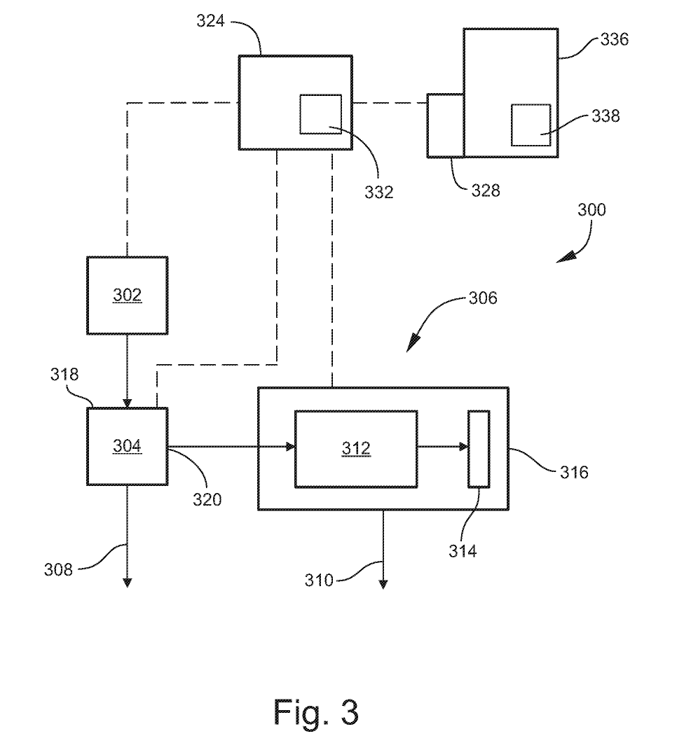

An example of a method for acquiring mass spectral data will now be described according to one embodiment. The method may be implemented by operating a mass spectrometer (MS) that includes an EI source and a mass analyzer, such as described by example below and illustrated in FIG. 3. In this method, the EI source produces an electron beam at a first electron energy. A sample that includes an analyte of interest is introduced into the EI source. In some embodiments, the EI source may be interfaced with a chromatograph, typically a GC, in which case the sample is flowed into the EI source from the GC column (or from a transfer line that intercouples the GC column with a sample inlet of the EI source. The sample is directed into the EI source so as to interact with the electron beam. Accordingly, the electron beam irradiates the sample (electrons bombard the sample) at the first electron energy to produce first analyte ions from the analyte of interest. As the first analyte ions are formed they are transmitted from an ion outlet of the EI source into the mass analyzer by appropriate means appreciated by persons skilled in the art. Transmitting ions “into the mass analyzer” encompasses not only transmitting the ions directly into the mass analyzer, but also transmitting ions into one or more intervening ion processing devices (ion guides, mass filters, collision cells, ion traps, beam shapers, etc.) that may be present and then ultimately into the mass analyzer. The mass analyzer separates and detects the first analyte ions, and a mass spectrum of the first analyte ions is generated, according to known principles.

While sample material still resides in the EI source, or while the sample continues to flow into the EI source, the electron energy is adjusted to a second electron energy different from the first electron energy. The electron beam then irradiates the sample at the second electron energy to produce second analyte ions from the analyte of interest. As the second analyte ions are formed they are transmitted to the mass analyzer, and a mass spectrum of the second analyte ions is generated.

As described above, in some embodiments the electron beam may be cycled between the first electron energy and the second electron energy one or more times. Moreover, the electron beam may be adjusted to more than two different electron energies to generate additional mass spectra that are based on additional electron energies.

In some embodiments, each mass spectrum generated may be stored as correlation data in a memory. The correlation data may correlate each mass spectrum with the electron energy utilized to generate the spectrum. The memory may be part of a controller (e.g., an electronic processor-based controller or computer) that is provided with the MS system, or a controller that is separate from the MS system (e.g., a desktop or portable computer, a handheld device, etc.). The controller utilized to acquire and correlate data may also control the operation of the EI device and/or other components of the MS. Alternatively, the memory may be a component located externally from the controller and accessible by the controller via a wired or wireless communication link. The correlation data may be utilized to build a spectral library (or database, or look-up table, etc.) for use in future research and experiments. Further, the present method may be carried out on a plurality of different analytes of interest, and the resulting correlation data for each analyte may be compiled in the spectral library.

In some embodiments, the method includes analyzing the mass spectra generated from the first and second electron energies (and from additional electron energies, if implemented) to determine which of the electron energies yields the highest abundance of a specific target analyte ion and/or the highest ratio of a specific target analyte ion to other fragment ions. The electron energy found to yield the highest abundance of the target analyte ion (and/or the highest ratio of a specific target analyte ion to other fragment ions) may be considered to be the “target” electron energy to be utilized in ionizing the analyte in question when formation of the target analyte ion is desired in a given experiment. The correlation between the target analyte ion and the target electron energy may be stored as data in a library for future use in manner analogous to that described above. Such correlations may be determined and stored for any number of different analytes.

In some embodiments, after determining the target electron energy for an analyte, the method includes introducing an additional amount of the sample containing the analyte of interest into the EI source, ionizing the sample at the target electron energy, and generating a mass spectrum. This may result in a strong signal for the target analyte ion useful in characterizing the analyte of interest.

In some embodiments, the method includes introducing the sample into the EI source by eluting the sample from a chromatographic column as a plurality of peaks, or bands, which sequentially enter of the EI source. One or more these peaks may contain compounds considered to be analytes of interest in a given experiment. Thus, the method described above may be carried out on one or more selected peaks of the elution. That is, each analyte of interest may be irradiated at the first electron energy to produce first analyte ions which are then transmitted out from the EI source to generate a mass spectrum based on the first electron energy, and then irradiated at the second electron energy to produce second analyte ions which are then transmitted out from the EI source to generate a mass spectrum based on the second electron energy, and this process may be repeated at additional electron energies as noted above. In this way, a plurality of different analytes may be surveyed at different energies for purposes such as described herein. The methods disclosed herein may also be utilized to ionize two or more different compounds that co-elute from the chromatographic column at the same or similar time. That is, two or more different compounds may have the same or slightly different retention times such that a peak or band transferred into the EI source includes the two or more different compounds. One or more of these co-eluting compounds may be analytes of interest to the experiment. The methods disclosed herein may be utilized to ionize co-eluting compounds at one or more different electron energies.

The different electron energies at which an analyte is to be ionized may be programmed into the EI source, such as by user input or by providing computer-readable instructions to a controller that controls the EI source (e.g., controls the voltage applied to the thermionic filament). In other embodiments, the method may implement an adaptive approach in which one or more electron energies may be selected or adjusted during the course of the experiment. For example, after irradiating the sample at the first electron energy and generating the first mass spectrum, the first mass spectrum may be analyzed or evaluated. The analysis or evaluation may be implemented or assisted by an appropriate algorithm executed by electronic processor-based firmware (i.e., a controller) and/or by software. Based on the spectral data provided by the first mass spectrum, a determination may be made as to what the value of the second electron energy should be. Thus, the second electron energy may be selected based on the spectral data from the first mass spectrum, and the electron beam may be adjusted accordingly. In some embodiments, the value selected for the second electron energy may replace a pre-programmed value. In some embodiments, this adaptive approach may be implemented during the elution time of a single peak. For example, the first mass spectrum may yield a piece of information (e.g., a certain m/z peak at a threshold minimum abundance) that triggers the controller to determine a value for the second electron energy and adjust the first electron energy to the second electron energy accordingly.

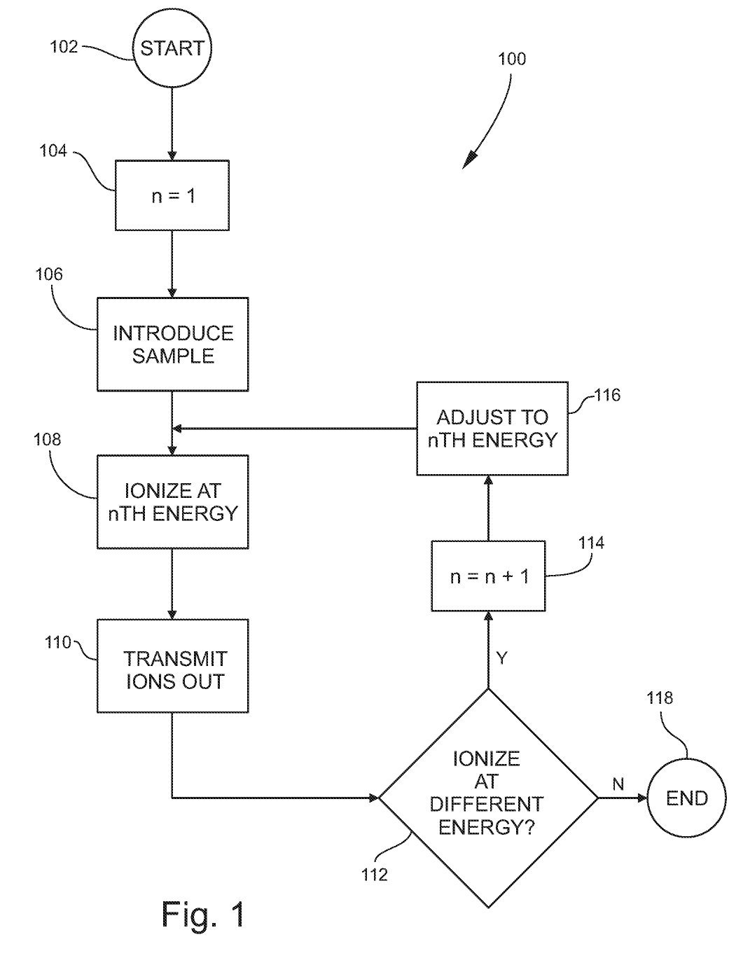

FIG. 1 is a flow diagram illustrating another example of a method 100 for acquiring mass spectral data. The method implements one or more iterations n of ionization at one or more different electron energies (n=1, 2, 3, . . . ). The start (102) of the method corresponds to the first iteration, so n is initially set to 1 (104). A sample is introduced (106) into an EI source. The sample is ionized at the nth (first) electron energy (108). The resulting ions are transmitted (110) out from the EI source for further processing, including mass analysis and the generation of a mass spectrum. Other processing prior to mass analysis may include, for example, mass filtering, fragmentation, etc., as appreciated by persons skilled in the art. A decision is then made (112) as to whether to ionize the sample at a different electron energy. The decision may be made by user input or in an automated or (pre-)programmed manner by hardware and/or software. If the decision is not to change the electron energy, the method may continue at the current electron energy or end (118). Otherwise, the method is advanced to the next (second) iteration and n is set to n+1 (114). The EI source adjusts (116) the electron beam to the next (second) electron energy, and the process of ionizing (108) the sample and transmitting (110) the resulting ions out from the EI source is repeated.

Method steps 108 to 116 may be repeated any number of times, and the EI source may be operated at any number of different electron energies. It will be noted that a different electron energy is not required for each new iteration. For example, the EI source may be cycled back and forth between 70 eV and 30 eV for a desired number of times, i.e., the first iteration is done at 70 eV, the second iteration is done at 30 eV, the third iteration is done at 70 eV, etc. As another example, the EI source may be cycled through 70 eV, 30 eV, and 10 eV for a desired number of times.

In another embodiment, FIG. 1 represents an MS system that includes components configured for carrying out the illustrated method 100.

According to another embodiment of a method for acquiring mass spectral data, one or more different electron energies at which an EI source is to operate are selected. The selections may be made to favor or promote forming one or more target analyte ions useful in identifying or otherwise characterizing one or more analytes of interest. For example, a first electron energy may be selected to preferentially produce a first target analyte ion known to be characteristic of a first analyte, and a second electron energy may be selected to preferentially produce a second target analyte ion known to be characteristic of a second analyte. The selection of electron energies may be based on one or more attributes of the sample to be ionized. Examples of attributes include, but are not limited to, the type of analyte of interest known to be or suspected of being included in the sample, the class of compounds that includes the analyte of interest known to be or suspected of being included in the sample, and the matrix with which the sample is to be introduced into the EI source. For instance, analysis of or testing for a certain class of environmental pollutants may call for ionization at a relatively high electron energy, while analysis of or testing for a certain class of steroids may call for ionization at a relatively low electron energy (i.e., softer ionization). As another example, an electron energy may be selected for its ability to reduce the adverse effects that a particular sample matrix may have on the ionization process or spectral analysis.

The selection process may be based on prior knowledge, such as may be developed by implementing other methods described herein. For example, the method may include operating a controller to access a memory in which correlation data is stored. The correlation data may correlate different analytes (or different attributes of a given type of sample) with respective electron energies to be utilized in the EI source.

After the selection is done, the method may include producing an electron beam in the EI source, and introducing in the EI source a sample known to include or suspected of including one or more analytes of interest. The sample is irradiated with the electron beam at a first electron energy to produce a first set of ions, and the first set of ions is transmitted out from the EI source. If a second electron energy has been selected, the electron beam is adjusted to the second electron energy, the sample is irradiated at the second electron energy to produce a second set of ions, the second set of ions is transmitted out from the EI source. This process may be repeated for additional analytes and additional selected electron energies. In this manner, the ionization pathway may be optimized for any number of different analytes, and highly informative mass spectra may be generated.

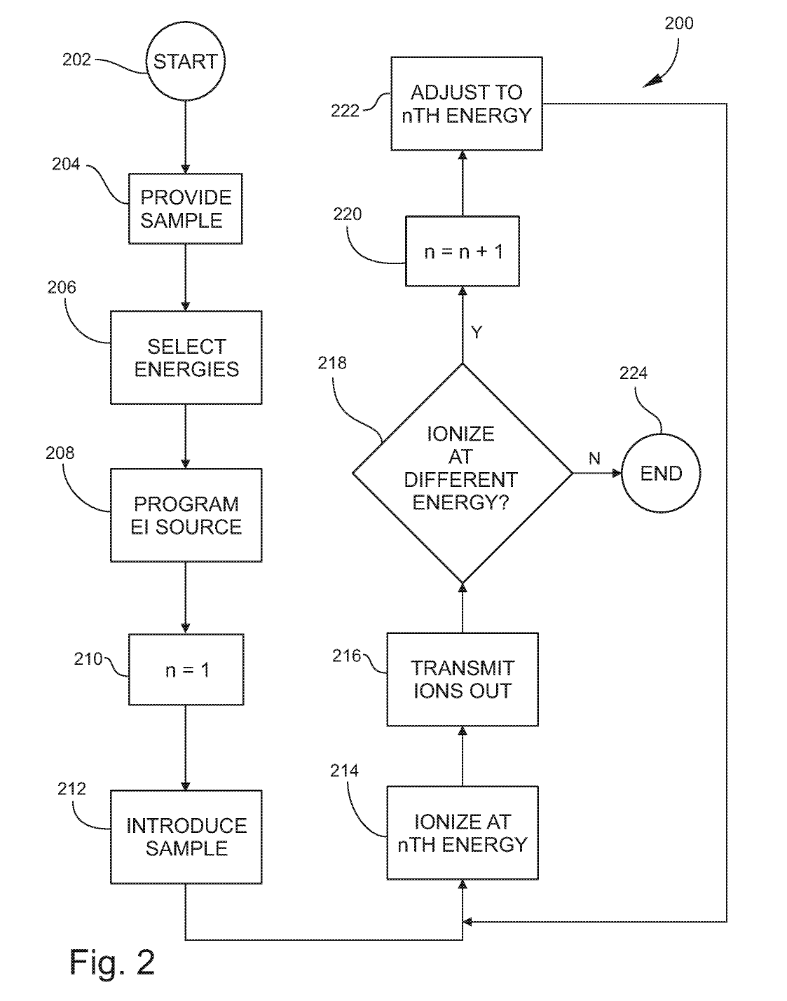

FIG. 2 is a flow diagram illustrating another example of a method 200 for acquiring mass spectral data. The method implements one or more iterations n of ionization at one or more different electron energies (n=1, 2, 3, . . . ). Upon starting (202) the method, a sample to be analyzed is provided (204). The sample is known to include one or more analytes of interest, or is suspected of including one or more analytes of interest. In either case, one or more different electron energies at which the sample is to be ionized are selected (204). For each analyte of interest, the electron energy selected is an optimal electron energy (or target electron energy) that will promote or favor the production of a target analyte ion known to be characteristic of that particular analyte of interest. The selection may be assisted by the use of a library (or database, look-up table, etc.) containing data that correlates or associates target electron energies with target analyte ions. In some embodiments, the data may have been generated by implementing other methods disclosed herein such as, for example, the method 100 illustrated in FIG. 1. After selecting the electron energy or energies, the EI source is programmed (208) to produce an electron beam at the selected electron energy or energies. The start of the ionization process corresponds to the first iteration, so n is set to 1 (210). The sample is introduced (212) into the EI source. The sample is ionized at the nth (first) electron energy (214). The resulting ions are transmitted (216) out from the EI source for further processing, including mass analysis and the generation of a mass spectrum. A determination is then made (218) as to whether the sample is to be ionized at a different electron energy (or, whether the program calls for adjusting to a different electron energy). If not, the method may end (224). Otherwise, the method is advanced to the next (second) iteration and n is set to n+1 (220). The EI source adjusts (222) the electron beam to the next (second) electron energy, and the process of ionizing (214) the sample and transmitting (216) the resulting ions out from the EI source is repeated. Method steps 214 to 222 may be repeated any number of times, and the EI source may be operated at any number of different electron energies, depending on the number of different target analyte ions being sought.

In another embodiment, FIG. 2 represents an MS system that includes components configured for carrying out the illustrated method 200.

In some embodiments of any of the methods disclosed herein, the EI source may be an axial EI source. The axial EI source may include an ionization chamber or volume having a length along a source axis that is coaxial with the ion outlet of the EI source. With this configuration, the method may include focusing the electron beam along the source axis, and irradiation of the sample produces an ion beam along the source axis. In some embodiments, the method may include applying an axial magnetic field to the ionization chamber to compress the electron beam along the source axis. In some embodiments, the method may include reflecting electrons of the electron beam back and forth along the source axis to intensify the electron beam, which may be particularly useful when running the EI source at low electron energies.

FIG. 3 is a schematic view of an example of a mass spectrometry (MS) system 300 that may be utilized in implementing methods disclosed herein. The MS system 300 generally includes a sample source 302, an ion source 304, a mass spectrometer (MS) 306, a system controller 324, and a vacuum system for maintaining the interiors of the ion source 304 and the MS 306 at controlled, sub-atmospheric pressure levels. The vacuum system is schematically depicted by vacuum lines 308 and 310 leading from the ion source 304 and the MS 306, respectively. The vacuum lines 308 and 310 are schematically representative of one or more vacuum-generating pumps and associated plumbing and other components appreciated by persons skilled in the art. It is also appreciated that one or more other types of ion processing devices (not shown) may be provided between the ion source 304 and the MS 306. The structure and operation of various types of sample sources, spectrometers, and associated components are generally understood by persons skilled in the art, and thus will be described only briefly as necessary for understanding the presently disclosed subject matter. In practice, the ion source 304 may be integrated with the MS 306 or otherwise considered as the front end or inlet of the MS 306, and thus in some embodiments may be considered as a component of the MS 306.

The sample source 302 may be any device or system for supplying a sample to be analyzed to the ion source 304. The sample may be provided in a gas-phase or vapor form that flows from the sample source 302 into the ion source 304. In hyphenated systems such as gas chromatography-mass spectrometry (GC-MS) systems, the sample source 302 may be a GC system, in which case an analytical column of the GC system is interfaced with a sample inlet 318 of the ion source 304 through suitable hardware.

The ion source 304 may be an orthogonal (or cross-beam, or Nier-type) EI source or an axial EI source. Both types of EI sources are described by example below. The ion source 304 includes an ion outlet 320 that is interfaced with the MS 306.

The MS 306 may generally include a mass analyzer 312 and an ion detector 314 enclosed in a housing 316. The vacuum line 310 maintains the interior of the mass analyzer 312 at very low (vacuum) pressure. In some embodiments, the mass analyzer 312 pressure ranges from 10⁻⁴ to 10⁻⁹ Torr. The vacuum line 310 may also remove any residual non-analytical neutral molecules from the MS 306. The mass analyzer 312 may be any device configured for separating, sorting or filtering analyte ions on the basis of their respective m/z ratios. Examples of mass analyzers include, but are not limited to, multipole electrode structures (e.g., quadrupole mass filters, ion traps, etc.), time-of-flight (TOF) analyzers, and ion cyclotron resonance (ICR) traps. The mass analyzer 312 may include a system of more than one mass analyzer, particularly when ion fragmentation analysis is desired. As examples, the mass analyzer 312 may be a tandem MS or MSⁿ system, as appreciated by persons skilled in the art. As another example, the mass analyzer 312 may include a mass filter followed by a collision cell, which in turn is followed by a mass filter (e.g., a triple-quad or QQQ system) or a TOF device (e.g., a qTOF system). The ion detector 314 may be any device configured for collecting and measuring the flux (or current) of mass-discriminated ions outputted from the mass analyzer 312. Examples of ion detectors 314 include, but are not limited to, electron multipliers, photomultipliers, and Faraday cups.

The system controller 324 is shown as being in signal communication with the sample source 302, ion source 304, MS 306, and a memory 328. The controller 324 may thus control various operations of the MS system 300, including programming and control of the filament and other components of ion source 304 involved in producing and maintaining the electron beam. The controller 324 may include a computer-readable medium or software 332 for implementing programmed control of the ion source 304 and other components. In some embodiments the controller 324 may implement (e.g., utilizing firmware and/or software), in whole or in part, one or more of the methods disclosed herein. The memory 328 may be utilized to store data acquired from experiments and build libraries or databases as described herein. The memory 328 may be local memory integrated with the controller 324 or, as illustrated, may be provided as a remote component accessible by the controller 324. In some embodiments, the memory 328 may be part of a remote computing device such as a database server 336. The database server 336 may include database software 338 stored in memory. The database server 336 may be configured for executing instructions of the database software 338 to create and maintain data in the memory 328 in an organized manner. In some implementations, the MS system 300 may be part of or in communication with a laboratory information management system (LIMS).

In some embodiments, the methods disclosed herein are facilitated by utilizing an axial (or on-axis) EI source as opposed to an orthogonal ion source. In the widely used orthogonal EI source, the ion beam is generated in a direction orthogonal the electron beam. This type of design is prone to loss of ions, due to a large number of ions being drawn out to the filaments or defocused and neutralized (lost) upon collision with the inner surfaces of the ionization chamber of the EI source. For many applications, it would be more advantageous to generate an on-axis electron beam, i.e., an electron beam that is coaxial with the resulting ion beam and with the mass analyzer 312 or other downstream device into which the ions are transmitted. An axial electron beam may be much more likely to create ions that would have a much higher likelihood of success of being transferred into the downstream device from the EI source. In addition, an axial electron beam provides a longer path along which analytes have an opportunity to interact with electrons, thereby enabling the creation of more analyte ions. Moreover, it has been discovered that carrying out the ionization process using an on-axis EI source promotes the formation of molecular ions and other high mass ions. Further, an on-axis EI source as disclosed herein is capable of generating and maintaining low-energy electron beams at intensities and ionization efficiencies that are sufficiently high for effectively implementing the methods disclosed herein, and which have not been previously attained by conventional EI sources.

FIG. 4 is a perspective view of an example of an ion source 400 according to some embodiments. FIG. 5 is a perspective cross-sectional view of the ion source 400 illustrated in FIG. 4. In the illustrated embodiment, the ion source 400 generally includes a body 404 defining an internal ionization chamber or volume 508, a magnet assembly 412, an electron source 416, and a lens assembly 420.

The ion source 400 may have an overall geometry or configuration generally arranged about a source axis 424. In operation, the ion source 400 produces an electron beam along the source axis 424, and may admit a stream of sample material to be ionized in any direction relative to the source axis 424. The sample material to be analyzed may be introduced to the ion source 400 by any suitable means, including hyphenated techniques in which the sample material is the output of an analytical separation instrument such as, for example, a gas chromatography (GC) instrument. The ion source 400 subsequently produces ions and focuses the ions into an ion beam along the source axis 424. The ions exit the ion source 400 along the source axis 424 and enter the next ion processing device, which may have an ion entrance along the source axis 424.

The ionization chamber 508 has a length along a source axis 424 from a first end to a second end. A sample inlet 528 is formed through the body 404 at any suitable location to provide a path for directing sample material from a sample source into the ionization chamber 508 where the sample material interacts with the electron beam. The axial length of the ionization chamber 508 may be selected to provide a relatively long viable electron beam region available to ionize the desired analyte molecules, thereby increasing the ionization efficiency of the ion source 400 and consequently the sensitivity of the instrument as a whole.

The magnet assembly 412 coaxially surrounds the body 404. The magnet assembly 412 is configured for generating a uniform axial magnetic field in the ionization chamber 508, which focuses and compresses the electron beam and the resulting ion beam along the source axis 424. The magnetically constrained electron beam and relatively long ionization chamber 508 may enable the generation of an ion beam well suited for improved extraction (emittance) out from the ionization chamber 508 and ultimately into a downstream ion processing device such as, for example, a mass analyzer, or another type of device that precedes the mass analyzer, such as an ion guide, an ion trap, a mass filter, a collision cell, etc. The ion beam may be extracted without suffering the ion losses known to occur in Nier-type ion sources, where a large number of ions are drawn out to the filaments or are defocused and neutralized (lost) upon collision with the inner surfaces of the ionization chamber 508. The magnet assembly 412 may include a plurality of magnets 432 circumferentially spaced from each other about the source axis 424. The illustrated embodiment includes a symmetrical arrangement of four magnets 432 that are affixed to ring-shaped yokes 434. The magnets 432 may be permanent magnets or electromagnets. The sample inlet 528, and other components such as electrical conduits, may be positioned in the gap between any pair of adjacent magnets 432. The magnets 432, although spaced from each other by gaps, are symmetrically arranged about the source axis 424 and the axial magnetic field generated is uniform.

The electron source 416 may be any device configured for producing electrons and directing an electron beam through the ionization chamber 508 from the first end. In the illustrated embodiment, the electron source 416 includes one or more cathodes 538. The cathode 538 is configured for thermionic emission, and thus may be or include one or more filaments (or alternatively coatings on cores) composed of a thermionically emissive material such as, for example, rhenium or tungsten-rhenium alloy. The cathode 538 is heated to a temperature sufficient to produce thermionic emission. Heating is typically done by running an electrical current through the cathode 538. The current may be adjusted to adjust the electron energy, which is typically set to around 70 eV but may be lower or higher. The electron source 416 also includes an ion repeller 540 and an electron reflector 544 (plate or electrode). The cathode 538 is positioned between the electron reflector 544 and the ion repeller 540 in what may be considered as an electron source region separated from the ionization chamber 508 by the ion repeller 540. The ion repeller 540 (which may also be considered to be an electron extractor) may be configured as a wall or plate having an aperture on the source axis 424. The electron energy is set by the voltages applied to the ion repeller 540 and the electron reflector 544. A voltage applied to the electron reflector 544 accelerates the as-generated electrons toward the lens assembly 420. For this purpose, an axial voltage gradient may be applied between the electron reflector 544 and any suitable conductive element (anode) downstream of the cathode 538, such as an “extractor” of the lens assembly 420 as described below. The voltage applied to the electron reflector 544 is typically negative but more generally is less positive than the ion repeller 540 and other downstream optics up to a “first lens element” of the lens assembly 420, described below. The electron reflector 544 and cathode 538 may be operated at equal potentials, or the electron reflector 544 may be more negative than the cathode 538 to assist in repelling electrons into the ionization chamber 508.

The lens assembly 420 is positioned at the second end of the ionization chamber 508, axially opposite to the electron source 416. The lens assembly 420 is configured, among other things, for directing an ion beam out from the ionization chamber 508 along the source axis 424 and into the next ion processing device. For this purpose, the lens assembly 420 includes a plurality of lens elements (or electrodes) independently addressable by voltage sources. Each lens element may have an aperture or slot on the source axis 424. In the illustrated embodiment, the lens assembly 420 includes an ion extraction lens (or ion extractor) 548, a first lens element (or electron reflector) 550 spaced from the extractor 548 along the source axis 424, a second lens element (or ion reflector) 552 spaced from the first lens element 550 along the source axis 424, and an ion source exit lens element (or ion beam focusing lens element) 556 spaced from the second lens element 552 along the source axis 424. The ion source exit lens element 556 may be configured or also serve as the entrance lens element into an ion processing device. The lens assembly 420 may also include one or more additional ion focusing lens elements 554 between the second lens element 552 and the ion source exit lens element 556, which may be utilized for focusing the ion beam. The ion repeller 540 and the extractor 548 may be considered as being the axial first and second ends, respectively, of the ionization chamber 508. As appreciated by persons skilled in the art, a voltage of appropriate magnitude may be applied to the extractor 548 to assist in drawing the ion beam out from the ionization chamber 508.

The first lens element 550 is positioned just outside the ionization chamber 508, and is directly adjacent to the extractor 548 on the downstream side thereof. A voltage of appropriate magnitude may be applied to the first lens element 550 to reflect the electron beam back into the ionization chamber 508. Accordingly, the cathode 538 (or the cathode 538 and electron reflector 544) and the first lens element 550 cooperatively work to reflect the electron beam back and forth through the ionization chamber 508 along the source axis 424, thereby intensifying the electron density available for EI ionization of analytes in the ionization chamber 508.

To reflect electrons back into the ionization chamber 508, a voltage of relatively high magnitude may be applied to the first lens element 550. This may result in the creation of ions generally in the region between the first lens element 550 and the extractor 548, which may be referred to as an ion trapping region. In comparison to the ionization chamber 508, the energy in this region is low and hence ions created in this region may have undesirably low ion energies. Consequently, these ions are subject to becoming trapped in this region. These ions may be referred to herein as “low energy” or “lower energy” or “trapped” ions, which in the present context refers to ions having energies low enough to be capable of being trapped in the trapping region under the operating conditions contemplated for the ion source 400. By comparison, “high energy” or “higher energy” or “non-trapped” ions, typically those produced in the ionization chamber 408, are capable of penetrating the lens assembly 420 and entering the downstream ion processing device. Ion trapping may lead to undesirable space charge and ion current instabilities, consequently resulting in undesirable erratic performance.

The second lens element 552 is provided to substantially reduce or eliminate ion trapping in the region between the second lens element 552 and the extractor 548. The voltage set on the second lens element 552 may be more positive than the voltage set on the first lens element 550. Consequently, the second lens element 552 reflects the low energy ions back toward the first lens element 550, and these ions then collide with the first lens element 550 and are neutralized.

In addition, the first lens element 550 may be positioned as close as practicable to the extractor 548 to minimize ion trapping in the trapping region.

In some embodiments, when initiating electron emission the “initial” electron energy may be set up as the potential difference between the thermionic cathode 538 and the ion repeller 540. This potential difference may be maintained at a desired fixed value as the voltage on the cathode 538 or ion repeller 540 changes, by adjusting the voltage on the other component. For example, the ion repeller 540 may be ramped and optimized while still maintaining proper electron energy offset, by adjusting the voltage on the cathode 538 such that it tracks the voltage on the electron reflector 544. Additionally, the voltage on the first lens element 550 may track the cathode voltage to optimize the electron reflecting function of the first lens element 550. The tracking functions may be implemented, for example, by the controller 324 schematically depicted in FIG. 3. As a default operation, the controller 324 may read the cathode voltage and apply the same value to the first lens element 550. To further allow for refinement in the optimization of the first lens element 550, an additional applied offset voltage may be ramped and summed in with the default applied cathode matching voltage, i.e., V_{FIRST LENS ELEMENT}=V_{CATHODE}+V_{OFFSET}. The application of the offset voltage may provide stronger reflection of electrons at the first lens element 550 to minimize incursion of the electrons into the ion trapping region between the first lens element 550 and the extractor 548, thereby further increasing the amount of the more viable high energy ions and reducing the amount of the undesirable low energy ions. Similarly, ramping electron energy varies the cathode voltage, and the voltage applied to the first lens element 550 may track the ramping cathode voltage as well.

In some applications, it may be desirable to reduce or eliminate the effects of electron space charge that develops in the ion source. For example, space charge effects may be significant enough to cause the electron beam to modulate uncontrollably thus adversely affecting the stability of the ion beam. To address this, in some embodiments a periodic voltage may be applied to one or more of the conductive elements of the electron source 416, lens assembly 420, and/or body 404. The periodic voltage may be a periodic DC pulse (with pulse width, period and amplitude empirically optimized) or a high-frequency (e.g., RF) potential. The periodic voltage may discharge any unwanted surface charge build up resulting from increasing levels of contamination. Alternatively, the electron beam may be gated to alleviate space charge build up, such as by employing appropriate electron optics to periodically deflect the electron beam away from the source axis. In some embodiments, space charge effects may be addressed by implementing techniques disclosed in U.S. Pat. No. 7,291,845, the entire content of which is incorporated by reference herein.

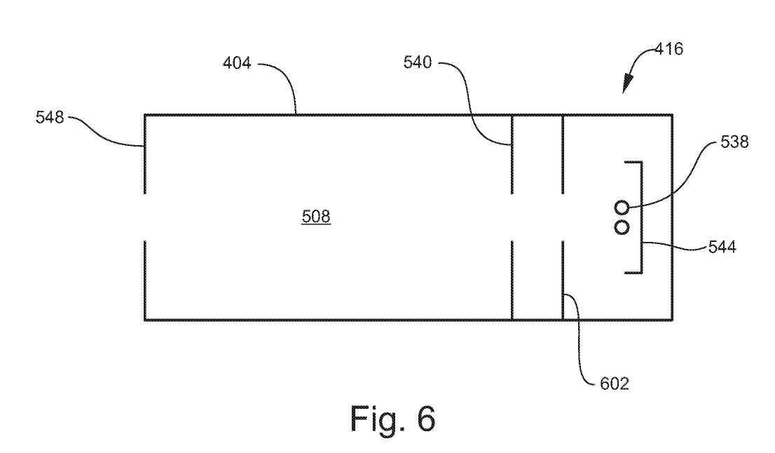

FIG. 6 is a schematic view of a portion of the ion source 400 illustrated in FIGS. 4 and 5 according to another embodiment. In this embodiment, an additional electrode (or electron extractor) 602 is added to the electron source 416 between the cathode (filament) 538 and the ion repeller 540. By applying an appropriate voltage to the electron extractor 602, the electron extractor 602 may be utilized to tune the electric field conditions in the electron source 416, particularly when operating at low electron energy (e.g., 9 eV to 25 eV). For example, the electron extractor 602 may assist in drawing electrons away from the cathode 538 and toward the ionization chamber 508, and keeping the potential difference between the source body 404 and ion repeller 540 low.

Further description of axial ion sources suitable for use in implementing methods disclosed herein is provided in U.S. patent application Ser. No. 13/925,623, titled “AXIAL MAGNETIC ION SOURCE AND RELATED IONIZATION METHODS,” filed concurrently with the present application, now issued as U.S. Pat. No. 9,117,617, the entire content of which is incorporated by reference herein.

### EXAMPLE 1

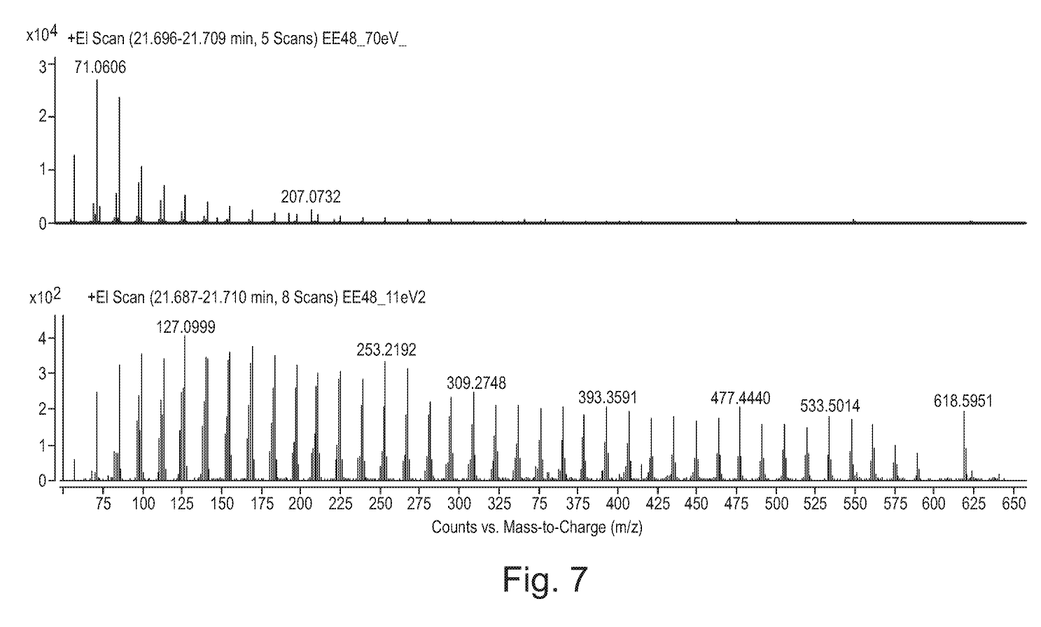

FIG. 7 illustrates mass spectra for n-tetracontane (C₄₄H₉₀, CAS# 7098-22-8, molecular weight: 618.72), or HC44, acquired by EI with 70 eV (upper spectrum) and 11 eV (lower spectrum) of electron energies, respectively. As noted above, 70 eV is a typical electron energy value in common, almost universal use, and 11 eV is in the range of EI soft ionization energies as taught herein. In the common practice using 70 eV, HC 44 is nearly identical to other linear hydrocarbons in its mass spectrum (upper spectrum) because the distinguishing molecular ion peak of HC44 is either missing or buried under noise. By comparison, rapidly to switching into soft EI mode (e.g., 11 eV of electron energy) under pre-set conditions, the HC44 can be identified unambiguously, as shown in the lower spectrum.

### EXAMPLE 2

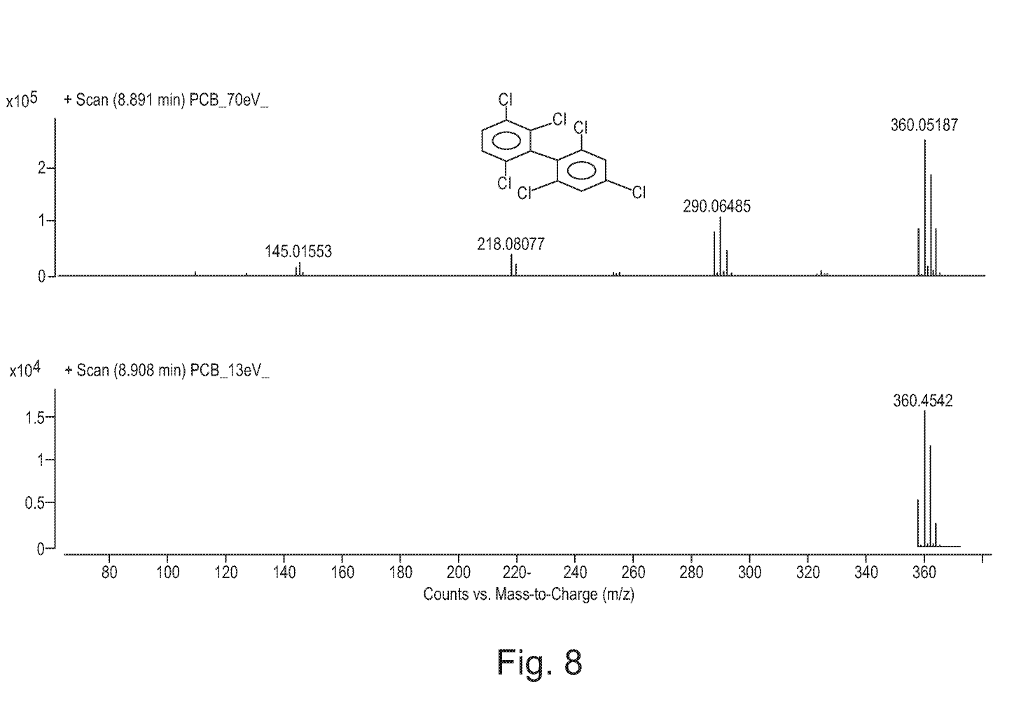

There are 209 different congeners of polychlorinated biphenyls (PCBs) with ten different degrees of chlorination. It is difficult to completely separate all of them by GC using standard configurations. Quantification of some of the PCBs using the 70 eV EI energy of common practice is a quite challenging task when they are not completely separated by GC because the fragment ion peaks of PCBs overlap each other, confounding confirmatory identification and obscuring molecular ions. FIG. 8 illustrates mass spectra for 2,2′,3,4′,6,6′-hexachloro-1,1′-biphenyl (C₁₂H₄Cl₆, molecular weight: 360.88 g/mol), acquired by EI with 70 eV (upper spectrum) and 13 eV (lower spectrum) of electron energies, respectively. It is clear that molecular ion peak is the only significant peak when the soft EI mode (e.g., 13 eV of electron energy) as taught herein is applied to ionize PCBs. Thus, the quantification of un-separated PCBs may be achieved simply by switching to 13 eV EI ionization during their eluting period.

### EXEMPLARY EMBODIMENTS

Exemplary embodiments provided in accordance with the presently disclosed subject matter include, but are not limited to, the following:
1. A method for acquiring mass spectral data, the method comprising: (a) producing an electron beam in an electron ionization (EI) source at a first electron energy; (b) introducing a sample comprising an analyte of interest into the EI source; (c) irradiating the sample with the electron beam at the first electron energy to produce first analyte ions from the analyte of interest; (d) transmitting the first analyte ions into a mass analyzer to generate a first mass spectrum correlated to the first electron energy; (e) adjusting the electron energy to a second electron energy different from the first electron energy; (f) irradiating the sample with the electron beam at the second electron energy to produce second analyte ions from the analyte of interest; and (g) transmitting the second analyte ions into the mass analyzer to generate a second mass spectrum correlated to the second electron energy.
2. The method of embodiment 1, comprising, after irradiating the sample at the second electron energy, cycling the electron beam between the first electron energy and the second electron energy one or more times, each time repeating the steps of irradiating the sample and transmitting ions into the mass analyzer.
3. The method of embodiment 1, comprising, after irradiating the sample at the second electron energy, generating one or more additional mass spectra based on one or more additional electron energies by repeating one or more times the steps of adjusting the electron energy, irradiating the sample, and transmitting ions into the mass analyzer.
4. The method of embodiment 3, wherein at least one of the additional electron energies is a third electron energy different from the first electron energy and from the second electron energy, wherein a third mass spectrum correlated to the third electron energy is generated.
5. The method of embodiment 3 or 4, comprising: (h) building a spectral library by storing correlation data in a memory, wherein the correlation data correlates each mass spectrum with the electron energy utilized to generate the mass spectrum.
6. The method of embodiment 5, comprising repeating steps (a) to (g) of embodiment 1 and step (h) of embodiment 5 a plurality of times for a plurality of different analytes of interest, wherein the correlation data correlates, for each analyte of interest, each mass spectrum generated from that analyte with the electron energy utilized to generate the mass spectrum.
7. The method of any of embodiments 1-6, comprising determining, from the first mass spectrum and the second mass spectrum, which of the first electron energy and the second electron energy is a target electron energy that yields the highest abundance of a target analyte ion, wherein the target analyte ion is an ion known to be characteristic of the analyte of interest.
8. The method of embodiment 7, comprising: generating one or more additional mass spectra based on one or more additional electron energies by repeating one or more times the steps of adjusting the electron energy, irradiating the sample, and transmitting ions into the mass analyzer; determining, from the one or more additional mass spectra, which of the one or more additional electron energies yields the highest abundance of the target analyte ion; and for the additional electron energy yielding the highest abundance of the target analyte ion, determining whether that additional electron energy yields a higher abundance of the target analyte ion than the first electron energy and the second electron energy.
9. The method of embodiment 8, comprising storing correlation data in a memory, wherein the correlation data correlates the target analyte ion with the target electron energy, and wherein the target electron energy is the electron energy yielding the highest abundance of the target analyte ion among the first electron energy, the second electron energy, and the one or more additional electron energies.
10. The method of any of embodiments 7-9, wherein the target analyte ion is a molecular ion or a high mass ion having a mass near the mass of the analyte of interest.
11. The method of any of embodiments 7-10, comprising: (h) storing correlation data in a memory, wherein the correlation data correlates the target analyte ion with the target electron energy.
12. The method of embodiment 11, comprising building a spectral library by repeating steps (a) to (g) of embodiment 1 and step (h) of embodiment 11 a plurality of times for a plurality of different analytes of interest, wherein the correlation data correlates, for each analyte of interest, a target analyte ion characteristic of that analyte with the target electron energy.
13. The method of embodiment 11 or 12, comprising adjusting the electron beam to the target electron energy, introducing an additional sample into the EI source, and ionizing the additional sample at the target electron energy.
14. The method of any of embodiments 1-13, wherein introducing the sample comprises eluting a peak comprising the analyte of interest from a chromatographic column.
15. The method of any of embodiments 1-13, wherein: the analyte of interest is a first analyte of interest; introducing the sample comprises eluting a plurality of peaks from a chromatographic column, including a first peak comprising the first analyte of interest, wherein each peak after the first peak comprises a respective analyte of interest different from the first analyte of interest, and the peaks sequentially enter the EI source; for each peak, performing the steps (c)-(g) of embodiment 1; wherein for each peak, a first mass spectrum based on the first electron energy and a second mass spectrum based on the second electron energy are generated.
16. The method of any of embodiments 1-15, wherein the first electron energy and the second electron energy are within a range from 9 eV to 150 eV.
17. The method of any of embodiments 1-15, wherein the first electron energy and the second electron energy are within a range from 9 eV to 25 eV.
18. The method of any of embodiments 1-17, comprising selecting the second electron energy based on spectral data provided by the first mass spectrum.
19. The method of embodiment 18, comprising operating a controller that controls the EI source to select the second electron energy.
20. The method of embodiment 18 or 19, wherein introducing the sample comprises eluting a peak comprising the analyte of interest from a chromatographic column, and selecting the second electron energy is performed while eluting the peak.
21. The method of any of embodiments 1-20, wherein the EI source is an axial EI source, wherein irradiating the sample produces an ion beam coaxial with the electron beam.
22. The method of any of embodiments 1-21, wherein the EI source comprises an ionization chamber having a length along a source axis coaxial with an ion outlet of the EI source, producing the electron beam comprises focusing the electron beam along the source axis, and irradiating the sample comprises producing an ion beam along the source axis.
23. The method of embodiment 22, comprising applying an axial magnetic field to the ionization chamber to compress the electron beam along the source axis.
24. The method of embodiment 22, comprising reflecting electrons of the electron beam back and forth along the source axis to intensify the electron beam.
25. A method for acquiring mass spectral data, the method comprising: selecting at least a first electron energy and a second electron energy at which an electron ionization (EI) source is to operate, wherein the second electron energy is different from the first electron energy; producing an electron beam in the EI source; introducing a sample into the EI source, wherein the sample is known to include or suspected of including at least a first analyte of interest and a second analyte of interest; irradiating the sample with the electron beam at the first electron energy to produce a first set of ions; transmitting the first set of ions out from the EI source; adjusting the electron energy to the second electron energy; irradiating the sample with the electron beam at the second electron energy to produce a second set of ions; and transmitting the second set of ions out from the EI source, wherein the first electron energy is selected to preferentially produce a first target analyte ion known to be characteristic of the first analyte of interest, and the second electron energy is selected to preferentially produce a second target analyte ion known to be characteristic of the second analyte of interest.
26. The method of embodiment 25, wherein selecting comprises operating a controller to select the first electron energy and the second electron energy based on an attribute of the sample.
27. The method of embodiment 26, comprising operating the controller to control production and adjustment of the electron beam.
28. The method of embodiment 26 or 27, wherein selecting comprises operating the controller to access a memory in which correlation data is stored, and wherein the correlation data correlates different attributes with respective electron energies to be utilized in the EI source.
29. The method of any of embodiments 26-28, wherein the attribute is selected from the group consisting of: the type of analyte of interest known to be or suspected of being included in the sample; the class of compounds that includes the analyte of interest known to be or suspected of being included in the sample; the matrix with which the sample is to be flowed into the EI source; and two or more of the foregoing.
30. The method of any of embodiments 25-29, wherein the sample is known to include or suspected of including one or more additional analytes of interest, and further comprising, for each additional analyte: adjusting the electron energy to an additional electron energy different from the first electron energy and the from second electron energy; irradiating the sample with the electron beam at the additional electron energy to produce an additional set of ions; and transmitting the additional set of ions out from the EI source, wherein the additional electron energy is selected to preferentially produce a target analyte ion known to be characteristic of the additional analyte of interest.
31. The method of any of embodiments 25-30, wherein the first target analyte ion is a molecular ion or a high mass ion having a mass near the mass of the first analyte of interest, and the second target analyte ion is a molecular ion or a high mass ion having a mass near the mass of the second analyte of interest.
32. The method of any of embodiments 25-31, wherein introducing the sample comprises eluting a first peak comprising the first analyte of interest and a second peak comprising the second analyte of interest from a chromatographic column.
33. The method of any of embodiments 25-32, comprising transmitting the first set of ions into a mass analyzer to generate a first mass spectrum, transmitting the second set of ions into the mass analyzer to generate a second mass spectrum.
34. The method of any of embodiments 25-33, wherein the EI source is an axial EI source, wherein irradiating the sample produces an ion beam coaxial with the electron beam.
35. A method for acquiring mass spectral data, the method comprising: producing an electron beam in the EI source; introducing a sample into the EI source; irradiating the sample with the electron beam at an electron energy of less than 70 eV to produce analyte ions; and transmitting the analyte ions out from the EI source.
36. The method of embodiment 35, comprising irradiating the sample with the electron beam at an electron energy in a range from 9 eV to 25 eV.
37. A method for acquiring mass spectral data, the method comprising: producing an electron beam in an electron ionization (EI) source at a first electron energy; introducing a first sample into the EI source; irradiating the first sample with the electron beam at the first electron energy to produce first analyte ions; transmitting the first analyte ions into a mass analyzer to generate a first mass spectrum; adjusting the electron energy to a second electron energy different from the first electron energy; introducing a second sample into the EI source; irradiating the second sample with the electron beam at the second electron energy to produce second analyte ions; and transmitting the second analyte ions into the mass analyzer to generate a second mass spectrum.
38. The method of embodiment 15, comprising building a spectral library by storing correlation data in a memory, wherein the correlation data correlates, for each sample, each mass spectrum with the electron energy utilized to generate the mass spectrum.
39. The method of embodiment 15, comprising selecting at least one of the first electron energy and the second electron energy to produce molecular ions.
40. The method of embodiment 15, wherein the at least one of first electron energy and the second electron energy is within a range from 9 eV to 25 eV.
41. The method of embodiment 1, comprising selecting the second electron energy based on spectral data provided by the first mass spectrum.
42. The method of embodiment 1, wherein the EI source is an axial EI source, and irradiating the sample produces an ion beam coaxial with the electron beam.
43. The method of any of the preceding embodiments, wherein: the EI source comprises an ionization chamber having a length along a source axis coaxial with an ion outlet of the EI source, an electron source comprising a thermionic cathode and an electron extractor, and an ion repeller between the ionization chamber and the electron extractor; producing the electron beam comprises emitting electrons from the cathode, drawing the emitted electrons away from the cathode by operating the electron extractor, and focusing the electron beam along the source axis; and irradiating the sample comprises producing an ion beam along the source axis.
44. A method for acquiring mass spectral data, the method comprising: (a) producing an electron beam in an axial electron ionization (EI) source at a first electron energy, and focusing the electron beam along a source axis of the EI source; (b) introducing a sample comprising an analyte of interest into the EI source; (c) irradiating the sample with the electron beam at the first electron energy to produce first analyte ions from the analyte of interest as an ion beam coaxial with the electron beam along the source axis; (d) transmitting the first analyte ions into a mass analyzer via a lens assembly of the EI source to generate a first mass spectrum correlated to the first electron energy; (e) adjusting the electron energy to a second electron energy different from the first electron energy; (f) irradiating the sample with the electron beam at the second electron energy to produce second analyte ions from the analyte of interest as an ion beam coaxial with the electron beam along the source axis; (g) transmitting the second analyte ions into the mass analyzer via the lens assembly to generate a second mass spectrum correlated to the second electron energy; and (h) reflecting at least some ions created in the lens assembly.
45. A method for acquiring mass spectral data, the method comprising: producing an electron beam in an axial electron ionization (EI) source at a first electron energy, and focusing the electron beam along a source axis of the EI source by applying a magnetic field; introducing a first sample into the EI source; irradiating the first sample with the electron beam at the first electron energy to produce first analyte ions as an ion beam coaxial with the electron beam along the source axis; transmitting the first analyte ions into a mass analyzer via a lens assembly of the EI source to generate a first mass spectrum; adjusting the electron energy to a second electron energy different from the first electron energy; introducing a second sample into the EI source; irradiating the second sample with the electron beam at the second electron energy to produce second analyte ions as an ion beam coaxial with the electron beam along the source axis; transmitting the second analyte ions into the mass analyzer via the lens assembly to generate a second mass spectrum; and while at least one of transmitting the first analyte ions or transmitting the second analyte ions, reflecting ions trapped in the lens assembly to prevent the trapped ions from exiting the lens assembly.
46. The method of embodiment 44 or 45, wherein the reflecting comprises applying a voltage to a lens element of the lens assembly.
47 The method of embodiment 46, wherein the lens assembly comprises a first lens element and a second lens element, and the reflecting comprises applying a voltage to the second lens element to reflect the at least some ions into collision with the first lens element.
48. The method of any of the preceding embodiments, comprising, after irradiating the sample at the second electron energy, cycling the electron beam between the first electron energy and the second electron energy one or more times, each time repeating the steps of irradiating the sample and transmitting ions into the mass analyzer.
49. The method of any of the preceding embodiments, comprising, after irradiating the sample at the second electron energy, generating one or more additional mass spectra based on one or more additional electron energies by repeating one or more times the steps of adjusting the electron energy, irradiating the sample, and transmitting ions into the mass analyzer.
50. The method of embodiment 49, comprising: building a spectral library by storing correlation data in a memory, wherein the correlation data correlates each mass spectrum with the electron energy utilized to generate the mass spectrum.
51. The method of any of the preceding embodiments, comprising determining, from the first mass spectrum and the second mass spectrum, which of the first electron energy and the second electron energy is a target electron energy that yields the highest abundance of a target analyte ion, or yields the highest ratio of a target analyte ion to other fragment ions, or yields both the highest abundance of a target analyte ion and the highest ratio of the target analyte ion to other fragment ions, wherein the target analyte ion is an ion known to be characteristic of the analyte of interest.
52. The method of embodiment 51, comprising: storing correlation data in a memory, wherein the correlation data correlates the target analyte ion with the target electron energy.
53. The method of any of the preceding embodiments, wherein: the analyte of interest is a first analyte of interest; introducing the sample comprises eluting a plurality of bands from a chromatographic column, including a first band comprising the first analyte of interest, wherein each band after the first band comprises a respective analyte of interest different from the first analyte of interest, and the bands sequentially enter the EI source; for each band, performing at least the steps (c)-(g) of embodiment 44; wherein for each band, a first mass spectrum based on the first electron energy and a second mass spectrum based on the second electron energy are generated.
54. The method of any of the preceding embodiments, comprising selecting the second electron energy based on spectral data provided by the first mass spectrum.
55. The method of embodiment 54, wherein introducing the sample comprises eluting a band comprising the analyte of interest from a chromatographic column, and selecting the second electron energy is performed while eluting the band.
56. The method of any of the preceding embodiments, comprising reflecting electrons of the electron beam back and forth along the source axis to intensify the electron beam.
57. The method of any of the preceding embodiments, wherein the sample is known to include or suspected of including at least a first analyte of interest and a second analyte of interest, and further comprising selecting the first electron energy to preferentially produce a first target analyte ion known to be characteristic of the first analyte of interest, and selecting the second electron energy to preferentially produce a second target analyte ion known to be characteristic of the second analyte of interest.
58. The method of any of the preceding embodiments, comprising selecting at least one of the first electron energy and the second electron energy based on an attribute of the sample.
59. The method of embodiment 58, wherein selecting comprises operating a controller to access a memory in which correlation data is stored, and wherein the correlation data correlates different attributes with respective electron energies to be utilized in the EI source.
60. The method of embodiment 58 or 59, wherein the attribute is selected from the group consisting of: a type of analyte of interest known to be or suspected of being included in the sample; a class of compounds that includes the analyte of interest known to be or suspected of being included in the sample; a matrix with which the sample is to be flowed into the EI source; and two or more of the foregoing.
61. The method of embodiment 45, comprising building a spectral library by storing correlation data in a memory, wherein the correlation data correlates, for each sample, each mass spectrum with the electron energy utilized to generate the mass spectrum.
62. The method of any of the preceding embodiments, comprising selecting at least one of the first electron energy and the second electron energy to produce molecular ions.
63. The method of any of the preceding embodiments, wherein the at least one of first electron energy and the second electron energy is within a range from 9 eV to 25 eV.
64. The method of any of the preceding embodiments, wherein at least one of the first electron energy and the second electron energy is in a range effective for producing the first analyte ions or the second analyte ions by soft ionization.
65. The method of any of the preceding embodiments, wherein the producing an electron beam comprises applying a voltage to a cathode of the EI source, and the adjusting the electron energy comprises adjusting the voltage on the cathode.
66. The method of embodiment 65, comprising, while adjusting the voltage on the cathode, adjusting a voltage on an ion repeller of the EI source positioned between the cathode and the lens assembly to maintain a fixed potential difference between the cathode and the ion repeller.
67. The method of embodiment 65 or 66, comprising applying a voltage to a lens element of the lens assembly to reflect the electron beam back into the ionization chamber and, while adjusting the voltage on the cathode, adjusting the voltage on the lens element by an equal amount.
68. The method of any of the preceding embodiments, wherein the producing an electron beam comprises applying a voltage to a cathode of the EI source, and further comprising applying a voltage to a lens element of the lens assembly to reflect the electron beam back into the ionization chamber.
69. The method of embodiment 68, comprising setting voltages applied to the cathode and the lens element to respective values sufficient for maintaining reflection of the electron beam between the cathode and the lens element.
70. The method of embodiment 69, comprising setting the voltages applied to the cathode and the lens element to equal values, or increasing the voltage applied to the lens element by an offset amount relative to the voltage applied to the cathode to increase reflection at the lens element.
71. The method of any of the preceding embodiments, comprising applying a voltage to an extractor of the lens assembly to transmit the first analyte ions and the second analyte ions from an ionization chamber of the EI source the ionization chamber into the lens assembly.
72. The method of embodiment 71, comprising applying a voltage to a first lens element of the lens assembly positioned outside the ionization chamber to reflect the electron beam through the extractor and into the ionization chamber.
73. The method of embodiment 72, comprising applying a voltage to a second lens element of the lens assembly to reflect the trapped ions into collision with the first lens element.
74. The method of any of the preceding embodiments, comprising applying a voltage to a lens element of the lens assembly to reflect the trapped ions into collision with another lens element of the lens assembly.
75. The method of any of the preceding embodiments, wherein the focusing the electron beam along the source axis comprises applying a magnetic field.
76. An ion source, comprising: an ionization chamber comprising a first end and a second end, and having a length along a source axis from the first end to the second end; an electron source positioned at the first end and configured to accelerate an electron beam through the ionization chamber along the source axis; a lens assembly positioned at the second end, the lens assembly configured to transmit analyte ions created in the ionization chamber out from the lens assembly along the source axis, and to reflect at least some ions created in the lens assembly; and a controller communicating with the electron source and the lens assembly, the controller configured to control an operation comprising: producing the electron beam at a first electron energy; introducing a sample comprising an analyte of interest into the EI source; irradiating the sample with the electron beam at the first electron energy to produce first analyte ions from the analyte of interest as an ion beam coaxial with the electron beam along the source axis; transmitting the first analyte ions into a mass analyzer via the lens assembly to generate a first mass spectrum correlated to the first electron energy; adjusting the electron energy to a second electron energy different from the first electron energy; irradiating the sample with the electron beam at the second electron energy to produce second analyte ions from the analyte of interest as an ion beam coaxial with the electron beam along the source axis; and transmitting the second analyte ions into the mass analyzer via the lens assembly to generate a second mass spectrum correlated to the second electron energy.
77. The ion source of embodiment 76, wherein the lens assembly comprises a first lens element and a second lens element spaced from the first lens element, and the second lens element is configured to reflect the at least some ions toward the first lens element.
78. The ion source of embodiment 77, wherein the lens assembly comprises an extractor spaced from the first lens element such that the first lens element is between the extractor and the second lens element, and the extractor is configured to direct the ion beams out from the ionization chamber along the source axis.
79. The ion source of embodiment 77 or 78, wherein the first lens element is configured to reflect the electron beam toward the electron source.
80. The ion source of embodiments 76-79 wherein the lens assembly is configured to reflect the electron beam toward the electron source.
81. The ion source of any of embodiments 76-80, wherein the controller is configured to control adjusting a voltage applied to a cathode of the electron source utilized to produce the electron beam.
82. The ion source of embodiment 81, wherein the controller is further configured to control an operation selected from the group consisting of: maintaining a fixed potential difference between the cathode and an ion repeller positioned at the first end between the cathode and the lens assembly, while adjusting the voltage applied to the cathode; adjusting a voltage applied to the lens assembly based on the adjustment of the voltage applied to the cathode; setting voltages applied to the cathode and the lens assembly to respective values sufficient to reflect the electron beam between the cathode and the lens assembly; setting voltages applied to the cathode and the lens assembly to respective values sufficient to reflect the electron beam between the cathode and the lens assembly, and adding a voltage offset to the lens assembly relative to the cathode to increase reflection of the electron beam from the lens assembly; and two or more of the foregoing.
83. The ion source of any of embodiments 76-82, wherein the lens assembly comprises a first lens element and a second lens element spaced from the first lens element, and controller is configured to control applying a voltage to the second lens element to a value sufficient to accelerate the trapped ions into collision with the first lens element.
84. The ion source of any of embodiments 76-83, comprising a magnet assembly surrounding the ionization chamber and configured to generate an axial magnetic field in the ionization chamber.
85. An electron ionization (EI) source configured for performing one or more of the steps of any one of the preceding methods.
86. A mass spectrometry (MS) system comprising an electron ionization (EI) source and configured for performing one or more of the steps of any one of the preceding methods.
87. A computer-readable storage medium comprising instructions for performing one or more of the steps of any one of the preceding methods.
88. A mass spectrometry (MS) system comprising the computer-readable storage medium of embodiment 87.

It will be understood that the system controller 324 schematically depicted in FIG. 3 may represent one or more modules configured for controlling, monitoring, timing, synchronizing and/or coordinating various functional aspects of the ion source. The system controller 324 may also represent one or more modules configured for controlling functions or components of the associated spectrometry system, including, for example, receiving the ion measurement signals and performing other tasks relating to data acquisition and signal analysis as necessary to generate a mass spectrum characterizing the sample under analysis.

For all such purposes, the controller 324 may include a computer-readable medium that includes instructions for performing any of the methods disclosed herein. The controller 324 is schematically illustrated as being in signal communication with various components of the ion source and other components via wired or wireless communication links represented by dashed lines. Also for these purposes, the controller 324 may include one or more types of hardware, firmware and/or software, as well as one or more memories and databases. The controller 324 typically includes a main electronic processor providing overall control, and may include one or more electronic processors configured for dedicated control operations or specific signal processing tasks. The system controller 324 may also schematically represent all voltage sources not specifically shown, as well as timing controllers, clocks, frequency/waveform generators and the like as needed for applying voltages to various components. The controller 324 may also be representative of one or more types of user interface devices, such as user input devices (e.g., keypad, touch screen, mouse, and the like), user output devices (e.g., display screen, printer, visual indicators or alerts, audible indicators or alerts, and the like), a graphical user interface (GUI) controlled by software, and devices for loading media readable by the electronic processor (e.g., logic instructions embodied in software, data, and the like). The controller 324 may include an operating system (e.g., Microsoft Windows® software) for controlling and managing various functions of the controller 324.

It will be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A method for acquiring mass spectral data, the method comprising:
(a) producing an electron beam in an axial electron ionization (EI) source at a first electron energy, and focusing the electron beam along a source axis of the EI source;
(b) introducing a sample comprising an analyte of interest into the EI source;
(c) irradiating the sample with the electron beam at the first electron energy to produce first analyte ions from the analyte of interest as an ion beam coaxial with the electron beam along the source axis;
(d) transmitting the first analyte ions into a mass analyzer via a lens assembly of the EI source to generate a first mass spectrum correlated to the first electron energy;
(e) adjusting the electron energy to a second electron energy different from the first electron energy;
(f) irradiating the sample with the electron beam at the second electron energy to produce second analyte ions from the analyte of interest as an ion beam coaxial with the electron beam along the source axis;
(g) transmitting the second analyte ions into the mass analyzer via the lens assembly to generate a second mass spectrum correlated to the second electron energy; and
(h) reflecting at least some ions created in the lens assembly.

2. The method of claim 1, wherein the reflecting comprises applying a voltage to a lens element of the lens assembly.

3. The method of claim 1, wherein the lens assembly comprises a first lens element and a second lens element, and the reflecting comprises applying a voltage to the second lens element to reflect the at least some ions into collision with the first lens element.

4. The method of claim 1, comprising, after irradiating the sample at the second electron energy, cycling the electron beam between the first electron energy and the second electron energy one or more times, each time repeating the steps of irradiating the sample and transmitting ions into the mass analyzer.

5. The method of claim 1, comprising, after irradiating the sample at the second electron energy, generating one or more additional mass spectra based on one or more additional electron energies by repeating one or more times the steps of adjusting the electron energy, irradiating the sample, and transmitting ions into the mass analyzer.

6. The method of claim 5, comprising: building a spectral library by storing correlation data in a memory, wherein the correlation data correlates each mass spectrum with the electron energy utilized to generate the mass spectrum.

7. The method of claim 1, comprising determining, from the first mass spectrum and the second mass spectrum, which of the first electron energy and the second electron energy is a target electron energy that yields the highest abundance of a target analyte ion, or yields the highest ratio of a target analyte ion to other fragment ions, or yields both the highest abundance of a target analyte ion and the highest ratio of the target analyte ion to other fragment ions, wherein the target analyte ion is an ion known to be characteristic of the analyte of interest.

8. The method of claim 7, comprising: storing correlation data in a memory, wherein the correlation data correlates the target analyte ion with the target electron energy.

9. The method of claim 1, wherein:
the analyte of interest is a first analyte of interest;
introducing the sample comprises eluting a plurality of bands from a chromatographic column, including a first band comprising the first analyte of interest, wherein each band after the first band comprises a respective analyte of interest different from the first analyte of interest, and the bands sequentially enter the EI source;
for each band, performing at least the steps (c)-(g) of claim 1;
wherein for each band, a first mass spectrum based on the first electron energy and a second mass spectrum based on the second electron energy are generated.

10. The method of claim 1, comprising selecting the second electron energy based on spectral data provided by the first mass spectrum.

11. The method of claim 10, wherein introducing the sample comprises eluting a band comprising the analyte of interest from a chromatographic column, and selecting the second electron energy is performed while eluting the band.

12. The method of claim 1, comprising reflecting electrons of the electron beam back and forth along the source axis to intensify the electron beam.

13. The method of claim 1, wherein the sample is known to include or suspected of including at least a first analyte of interest and a second analyte of interest, and further comprising selecting the first electron energy to preferentially produce a first target analyte ion known to be characteristic of the first analyte of interest, and selecting the second electron energy to preferentially produce a second target analyte ion known to be characteristic of the second analyte of interest.

14. The method of claim 1, comprising selecting at least one of the first electron energy and the second electron energy based on an attribute of the sample.

15. The method of claim 14, wherein selecting comprises operating a controller to access a memory in which correlation data is stored, and wherein the correlation data correlates different attributes with respective electron energies to be utilized in the EI source.

16. The method of claim 14, wherein the attribute is selected from the group consisting of:
a type of analyte of interest known to be or suspected of being included in the sample;
a class of compounds that includes the analyte of interest known to be or suspected of being included in the sample;
a matrix with which the sample is to be flowed into the EI source; and
two or more of the foregoing.

17. The method of claim 1, wherein at least one of the first electron energy and the second electron energy is in a range effective for producing the first analyte ions or the second analyte ions by soft ionization.

18. A method for acquiring mass spectral data, the method comprising:
producing an electron beam in an axial electron ionization (EI) source at a first electron energy, and focusing the electron beam along a source axis of the EI source by applying a magnetic field;
introducing a first sample into the EI source;
irradiating the first sample with the electron beam at the first electron energy to produce first analyte ions as an ion beam coaxial with the electron beam along the source axis;
transmitting the first analyte ions into a mass analyzer via a lens assembly of the EI source to generate a first mass spectrum;
adjusting the electron energy to a second electron energy different from the first electron energy;
introducing a second sample into the EI source;
irradiating the second sample with the electron beam at the second electron energy to produce second analyte ions as an ion beam coaxial with the electron beam along the source axis;
transmitting the second analyte ions into the mass analyzer via the lens assembly to generate a second mass spectrum; and
reflecting at least some ions created in the lens assembly.

19. The method of claim 18, comprising reflecting electrons of the electron beam back and forth along the source axis to intensify the electron beam.

20. An ion source, comprising:
an ionization chamber comprising a first end and a second end, and having a length along a source axis from the first end to the second end;
an electron source positioned at the first end and configured to accelerate an electron beam through the ionization chamber along the source axis;
a lens assembly positioned at the second end, the lens assembly configured to transmit analyte ions created in the ionization chamber out from the lens assembly along the source axis, and to reflect at least some ions created in the lens assembly; and
a controller communicating with the electron source and the lens assembly, the controller configured to control an operation comprising:
producing the electron beam at a first electron energy;
introducing a sample comprising an analyte of interest into the EI source;
irradiating the sample with the electron beam at the first electron energy to produce first analyte ions from the analyte of interest as an ion beam coaxial with the electron beam along the source axis;
transmitting the first analyte ions into a mass analyzer via the lens assembly to generate a first mass spectrum correlated to the first electron energy;
adjusting the electron energy to a second electron energy different from the first electron energy;
irradiating the sample with the electron beam at the second electron energy to produce second analyte ions from the analyte of interest as an ion beam coaxial with the electron beam along the source axis; and
transmitting the second analyte ions into the mass analyzer via the lens assembly to generate a second mass spectrum correlated to the second electron energy.
